(19) United States
(12) Patent Application Publication
(10) Pub. No.: US 2021/0065021 A1
(43) Pub. Date: Mar. 4, 2021

(54) WORKING CONDITION STATE MODELING AND MODEL CORRECTING METHOD

(71) Applicant: SHENYANG INSTITUTE OF AUTOMATION, CHINESE ACADEMY OF SCIENCES, Liaoning (CN)

(72) Inventors: Wenli SHANG, Liaoning (CN); Peng ZENG, Liaoning (CN); Xianda LIU, Liaoning (CN); Jianming ZHAO, Liaoning (CN); Long YIN, Liaoning (CN); Chunyu CHEN, Liaoning (CN); Jiansong AO, Liaoning (CN); Guoyu TONG, Liaoning (CN)

(73) Assignee: SHENYANG INSTITUTE OF AUTOMATION, CHINESE ACADEMY OF SCIENCES, Liaoning (CN)

(21) Appl. No.: 16/636,736

(22) PCT Filed: Feb. 21, 2019
(86) PCT No.: PCT/CN2019/075663

§ 371 Date: Feb. 5, 2020

(30) Foreign Application Priority Data
Dec. 17, 2018 (CN) 201811541159.9

(51) Int. Cl. G06N 5/04; G06K 9/62; G06N 7/00

(52) U.S. Cl. CPC G06N 5/04; G06K 9/6272; G06N 7/005; G06K 9/6203; G06K 9/6223

(57) ABSTRACT

The present invention relates to a working condition state modeling and model correcting method, comprising collecting data, and arranging the data in a chronological order to form a time sequence data set; preprocessing the time sequence data set; clustering the preprocessed time sequence data set, computing a central point data set of the duster, and generating a working condition data set and a working condition process data set; counting a working condition transition probability for the working condition process data set to form a working condition transition probability model data set; collecting the data, and detecting and processing the data; computing a working condition state transition mode phase by phase and processing. The present invention is based on a counting modeling method, introduces expert prior knowledge to correct the established model gradually, enables the model range to cover the overall system working condition state and solves the problem of low coverage rage in the mechanism analysis modeling methods and the counting modeling method, The present invention can be used as the input of an abnormal working condition diagnosis method, and can effectively improve the accuracy rate of abnormality diagnosis.

### TECHNICAL FIELD

The present invention relates to the technical field of computer science, in particular to a working condition state modeling and model correcting method.

### BACKGROUND

The maintenance function has become more and more important in the past few decades. Unexpected downtime may greatly influence the maintenance function, and will cause operational disruption and productivity loss, or even production accidents, it is difficult to realize timely maintenance under limited maintenance resources and personnel. The efficiency of abnormality diagnosis methods often depends on the quality of diagnosis models. The methods of establishing mathematical models can be roughly classified into two categories: mechanism analysis modeling methods and statistical modeling methods.

The mechanism analysis modeling method is to establish a mathematical equation between key variables and other measurable variables according to the physical and chemical laws in the production process from a process mechanism, and to establish a mathematical model of a system of equations describing the process through derivation. This modeling has the advantage that the internal structure and relationship of the system can be clearly shown, and the nature of the actual process is reflected, However, this method is difficult to model, long in cycle and difficult to obtain various structural parameters and physical parameters in the model, and is limited in the application.

The statistical modeling method is to directly model a system as a black box only according to the relationship between input and output data in a research object instead of analyzing its internal mechanism. The model has strong online correction capability, and can be applicable to highly nonlinear and seriously uncertain systems, so as to provide an effective way for solving the model problem of complex system process parameters. However, the statistical modeling method has certain limitations. For complex nonlinear processes, sample data generally only comprises some areas, and cannot cover the entire area. The increase of the range of a sample data set may cause a complex model and increased difficulty in solving.

### SUMMARY

Aiming at the defects of the prior art, the present invention provides a working condition state modeling and model correcting method, which introduces expert prior knowledge based on the statistical modeling method to solve the problem that the existing statistical modeling method cannot cover the whole area.

To realize the above-mentioned purpose, the present invention adopts the technical solution:

A working condition state modeling and model correcting method comprises the following steps:

step 1: collecting data, and arranging the data in a chronological order to form a time sequence data set;

step 2: preprocessing the time sequence data set;

step 3: clustering the preprocessed time sequence data set, computing a central point data set of the cluster, and generating a working condition data set and a working condition process data set;

step 4: counting a working condition transition probability for the working condition process data set to form a working condition transition probability model data set;

step 5: collecting the data, and detecting and processing the data;

step 6: computing a working condition state transition mode phase by phase and processing.

The step 1 comprises:

marking time sequence labels for the collected data (x₁, x₂, . . . , xₘ) to form a time sequence data set (tᵢ, xᵢ₁, xᵢ₂, . . . , xᵢₘ),wherein m represents the number of parameters; tᵢ represents the time sequence labels which are gradually increased; and x represents different parameters.

The step 2 comprises:

deleting irrelevant parameters in the time sequence data in the time sequence data set tᵢ, xᵢ₁, xᵢ₂, . . . , xᵢₘ) to obtain a time sequence data set (tᵢ, xᵢ₁, xᵢ₂, . . . , xᵢₙ) after dimension reduction, n≤m, wherein tᵢ represents the time sequence labels which are gradually increased; m represents the number of parameters; n represents the number of parameters after dimension reduction; and x represents different parameters.

The dimension reduction comprises:

respectively computing a variance for each dimension of the parameters to obtain (σ₁, σ₂, . . . , σₘ); computing the mean value

$$\overline{σ} = \frac{( {σ}_{1} + {σ}_{2} + ⋯ + {σ}_{m} )}{m}$$

of the variance, and deleting the values in (σ₁, σ₂, . . . , σₘ) that are less than Σ̅ to obtain (σ₁, σ₂, . . . , σₙ), thereby obtaining a time sequence data set (tᵢ, xᵢ₁, xᵢ₂, . . . , xᵢₙ) after dimension reduction; wherein tᵢ represents the time sequence labels which are gradually increased; m represents the number of parameters; n represents the number of parameters after dimension reduction; x represents different parameters; and σₘ represents variances of corresponding parameters.

A k-means algorithm is used for clustering, specifically:

the input serving as a data set (xᵢ₁, xᵢ₂, . . . , xᵢₙ) after dimension reduction, the range of k values being [Kₘᵢₙ, Kₘₐₓ];

conducting k-means clustering on the data set (xᵢ₁, xᵢ₂, . . . , xᵢₙ) after dimension reduction for each k value, and solving the sum of squared errors (SSE) value in clusters for each clustering result;

using cluster partitions (C₁, C₂, . . . , C_{K}) as output when min(SSE) is taken,

wherein C₁, C₂, . . . , C_{K} represent a set of clusters, and K represents the number of partitioned clusters, i.e., the number of working condition types.

The generating the working condition data set and the working condition process data set comprises:

firstly, marking the cluster partitions (C₁, C₂, . . . , C_{K}) of the data set (xᵢ₁, xᵢ₂, . . . , xᵢₙ) with the working condition types to form a working condition data set expressed as (xᵢ₁, xᵢ₂, . . . , xᵢₙ, yₖ); and simultaneously, respectively computing the central points of the cluster partitions to form a central point data set (cₖ₁, cₖ₂, . . . , cₖₙ, yₖ),wherein y represents the working condition types and the number of y is the same as the number of the cluster partitions, i.e., k≤K; C represents parameters corresponding to the working condition data set (xᵢ₁, xᵢ₂, . . . , xᵢₙ, yₖ);

then, computing a distance from each data in a cluster to a central node in the cluster, and taking a maximum distance value Dₘₐₓ;

finally, adding the time sequence labels for the working condition data set by taking the time sequence data set as a reference, to form a working condition process data set expressed as tᵢ, xᵢ₁, xᵢ₂, . . . , xᵢₙ, yₖ) ,wherein y represents the working condition types and the number of y is the same as the number of the cluster partitions, i.e., k≤K; tᵢ represents the time sequence labels which are gradually increased.

The working condition transition probability model data set is P(yₐ_{_{M+1}}|yₐ_{₁}, yₐ_{₂}, yₐ_{₃}, . . . , yₐ_{_{M}}), wherein M is a window size;

$$⌊ M \leq \frac{K}{2} ⌋ ;$$

K is the number of the working condition types; 1≤a₁, a₂, a₃, a_{M}, a_{M+1}≤n; and n represents the number of the parameters after dimension reduction,

In the working condition transition mode yₐ_{₁}, yₐ_{₂}, yₐ_{₃}, . . . , yₐ_{_{M}}, a working condition type yₐ_{₁} appears firstly, then a working condition type yₐ_{₂} appears and next a working condition type yₐ_{₃} appears, and so on until the working condition type yₐ_{_{M}} appears, wherein 1≤a₁, a₂, a₃, aₘ≤n, and n represents the number of the parameters after dimension reduction.

The collecting the data, and detecting and processing the data comprises:

collecting the data and taking n-dimensional parameters as input data (x′₁, x′₂, . . . , x′ₙ), wherein n represents the number of the parameters after dimension reduction, and the parameters are the same as the parameters selected in the data set (xᵢ₁, xᵢ₂, . . . , xᵢₙ) after dimension reduction; computing a distance from the input data to the central point data set, and taking a minimum value d of the distance;

if d≤Dₘₐₓ, taking the working condition type of the central point with a distance of d; adding the time sequence labels to form time sequence data (t′, x′₁, x′₂, . . . , x′ₙ, y′); and saving the data into a data set (t′₁, x′ᵢ₁, x′ᵢ₂, . . . , x′ᵢₙ y′_{k′}) to be processed;

d>Dₘₐₓ indicating that the input data is not matched with any working condition type; and modifying the working condition data set and the central point data set, wherein Dₘₐₓrepresents the maximum value of the distance from each data in the cluster to the central node in the cluster.

The step 6 comprises:

continuously taking the working condition transition mode (yᵢ, yᵢ₊₁, . . . , y_{M}, y_{M+1}) with a sliding window size of M for the data set (t′ᵢ, x′ᵢ₁, x′ᵢ₁, . . . , x′ᵢₙ, y′_{k′}) to be processed according to the chronological order; inquiring and counting the probability p in the working condition transition probability model; if p>ϵ, continuing to compute the working condition of the time sequence of a next group of data parameters; if 0≤p≤ϵ, correcting a corresponding probability in the working condition transition probability model, wherein a represents ϵ probability value defined according to expert knowledge.

The corresponding probability in the working condition transition probability model comprises:

when p=0, adding a probability value of the working condition transition mode to be corrected to the working condition transition probability model, recorded as ϵ; accordingly, reducing the probability values of other working condition transition modes in the data set of the working condition transition probability model on average;

when 0<p≤ϵ, modifying the probability value of the working condition transition mode to be corrected to the working condition transition probability model, recorded as p+ϵ; accordingly, reducing the probability values of other working condition transition modes in the data set of the working condition transition probability model on average,

wherein ∈ represents a probability value defined according to expert knowledge, and ∈=ϵ.

The present invention has the following beneficial effects and advantages:

1. The present invention is based on a counting modeling method, introduces expert prior knowledge to correct the established model gradually, enables the model range to cover the overall system working condition state and solves the problem of low coverage rage in the mechanism analysis modeling methods and the counting modeling method.

2. The present invention can be used as the input of an abnormal working condition diagnosis method, and can effectively improve the accuracy rate of abnormality diagnosis.

### DESCRIPTION OF DRAWINGS

FIG. 1 is a flow chart of establishing a working condition state model.

FIG. 2 is a flow chart of correcting a working condition state model.

FIG. 3 is a schematic diagram of a working condition transition mode with a window size of 2.

### DETAILED DESCRIPTION

The present invention will be further described in detail below in combination with the drawings and the embodiments.

To make the above-mentioned purpose, features and advantages of the present invention more clear and understandable, specific embodiments of the present invention will be described below in detail in combination with the drawings. In the following description, many specific details are elaborated to thoroughly understand the present invention. However, the present invention can be implemented in other modes different from those described herein. Those skilled in the art can make similar improvement without departing from the connotation of the present invention. Therefore, the present invention is not limited by specific embodiments disclosed below.

Unless otherwise defined, all technical and scientific terms used herein have the same meanings as those generally understood by those skilled in the art in the present invention. The terms used in the description of the present invention are intended to merely describe concrete embodiments, not to limit the present invention.

FIG. 1 is a flow chart of establishing a working condition state model.

Step 1: collecting data, and forming time sequence data; collecting the gathered data and representing the data as (x₁, x₂, . . . , xₘ), wherein m represents the number of parameters; marking the time sequence labels to form a time sequence data set represented as (tᵢ, xᵢ₁, xᵢ₂, . . . , xᵢₘ), wherein tᵢ represents the time sequence labels which are gradually increased; and m represents the number of parameters; the collected data is the data taken from a real-time database in a site production process.

Step 2: preprocessing the time sequence data parameters. The preprocessing course is to delete irrelevant parameter from the time sequence data set (tᵢ, xᵢ₁, xᵢ₂, . . . , xᵢₘ) to obtain a time sequence data set after dimension reduction, represented as (tᵢ, xᵢ₁, xᵢ₂, . . . , xᵢₙ), m≤m, wherein n represents the number of the parameters after dimension reduction and x represents different parameters. The specific dimension reduction process is as follows:

respectively computing a variance for each dimension of the parameters to obtain (σ₁, σ₂, . . . , σₘ); computing the mean value of the variances

$$\overline{σ} = \frac{( {σ}_{1} + {σ}_{2} + ⋯ + {σ}_{m} )}{m} ;$$

deleting me values in (σ₁, σ₂, . . . , σₘ) less than σ̅ to obtain (σ₁, σ₂, . . . , σₙ); accordingly, obtaining a time sequence data set (tᵢ, xᵢ₁, xᵢ₂, . . . , xᵢₙ,) after dimension reduction, wherein tᵢ represents the time sequence labels which are gradually increased; m represents the number of parameters; n represents the number of parameters after dimension reduction; x represents different parameters; and σₘ represents variances of corresponding parameters. The time sequence labels are not considered during dimension reduction.

Step 3: clustering the preprocessed time sequence data set, computing a central point data set of the cluster, and generating a working condition data set and a working condition process data set, and comprising the following specific steps:

firstly, clustering the preprocessed time sequence data sets, and neglecting the time labels during clustering, i.e., the time labels have no influence on the clustering result; using a k-means algorithm for clustering; input: a data set (xᵢ₁, xᵢ₂, . . . , xᵢₙ) after dimension reduction, and the range [Kₘᵢₙ, Kₘₐₓ] of k values needs to be determined according to expert knowledge; process: conducting k-means clustering on the data set (xᵢ₁, xᵢ₂, . . . , xᵢₙ) after dimension reduction for each k value, and solving the sum of squared errors (SSE) value in clusters for each clustering result; output: using cluster partitions C=(C₁, C₂, . . . , Cₖ) when min(SSE) is taken, wherein C₁, C₂, . . . , C_{K} represent a set of clusters, and K represents the number of partitioned clusters, i.e., the number of working condition types.

Then, marking the cluster partitions (C₁, C₂, . . . , C_{K}) of the data set (xᵢ₁, xᵢ₂. . . , xᵢₙ) with the working condition types according to the expert knowledge to form a working condition data set expressed as (xᵢ₁, xᵢ₂, . . . , xᵢₙ, yₖ); and simultaneously, respectively computing the central points of the cluster partitions to form a central point data set (cₖ₁, cₖ₂, . . . , cₖₙ, yₖ), wherein y represents the working condition types and the number of y is the same as the number of the cluster partitions, i.e., k≤K; c represents parameters corresponding to the working condition data set (xᵢ₁, xᵢ₂, . . . , xᵢₙ, yₖ).

Next, computing a distance from each data in a cluster to a central node in the cluster, and taking a maximum distance value Dₘₐₓ.

Finally, adding the time sequence labels for the working condition data set by taking the time sequence data set as a reference, to form a working condition process data set expressed as (tᵢ, xᵢ₁, xᵢ₂, . . . , xᵢₙ, yₖ), wherein y represents the working condition types and the number of y is the same as the number of the cluster partitions, i.e., k≤K; tᵢ represents the time sequence labels which are gradually increased.

Step 4: counting a working condition transition probability for the working condition process data set to form a working condition transition probability model data set. counting a working condition transition probability for the working condition process data set (tᵢ, xᵢ₁, xᵢ₂, . . . xᵢₙ, yₖ) in the step 3 according to the size of a sliding window M; representing the formed working condition transition probability model data set as P(yₐ_{_{M+1}}|yₐ_{₁}, yₐ_{₂}, yₐ_{₃}, . . . , yₐ_{_{M}}) , i.e., the emergence probability of yₐ_{₁}, yₐ_{₂}, yₐ_{₃}, . . . , yₐ_{_{M}}→yₐ_{_{M+1}} counted from the working condition process data set, namely the working condition process counts the corresponding probability according to the emergence order of the working condition transition modes yₐ_{₁}, yₐ_{₂}, yₐ_{₃}, . . . yₐ_{_{M}}, yₐ_{_{M+1}}, wherein M is a window size;

$$⌊ M \leq \frac{K}{2} ⌋ ;$$

K is the number of the working condition types; 1≤a₁, a₂, a₃, a_{M}, a_{M+1}≤n; and n represents the number of the parameters after dimension reduction.

Step 5: continuing to collect the data after the model is built, and correcting an original model; collecting the data and taking n-dimensional parameters as input data (x′₁, x′₂, . . . , x′ₙ), wherein n represents the number of the parameters after dimension reduction, and the parameters are the same as the parameters selected in the data set (xᵢ₁, xᵢ₂, . . . , xᵢₙ) after dimension reduction; computing a distance from the input data to the central point data set, and taking a minimum value d of the distance; if d≤Dmax, taking the working condition type of the central point with a distance of d; adding the time sequence labels to form time sequence data (t′, x′₁, x′₂, . . . , x′ₙ, y′); and saving the data into a data set to be processed; d>Dₘₐₓ indicating that the input data is not matched with any working condition type; and modifying the working condition data set and the central point data set, wherein Dₘₐₓ represents the maximum value of the distance from each data in the cluster to the central node in the cluster.

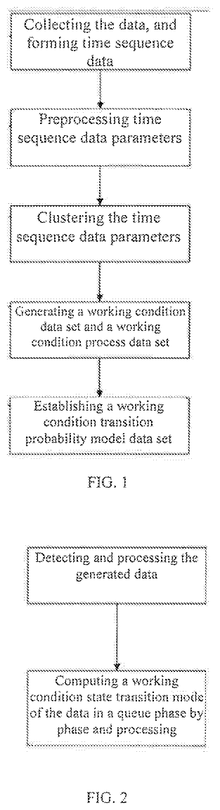

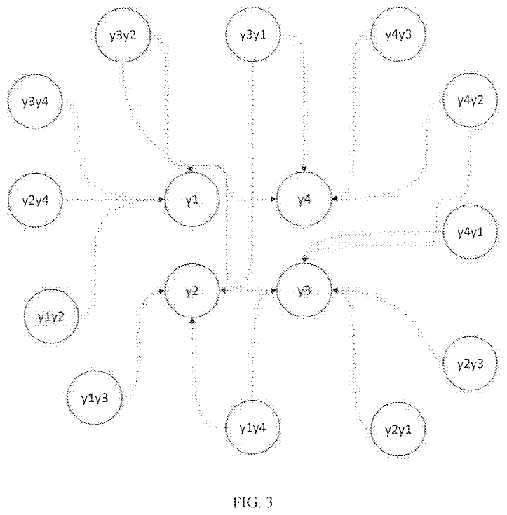

FIG. 2 shows a flow chart of correcting a working condition state model.

(1) The process of modifying the working condition data set is as follows:

directly adding the data (x′₁, x′₂, . . . , x′ₙ, y′) to the working condition data set

(2) The process of modifying the central point data set is as follows:

directly adding the data (x′₁, x′₂, . . . , x′ₙ, y′) to the central point data set (cₖ₁, cₖ₂, . . . , cₖₙ, yₖ).

Step 6: computing a working condition state transition mode phase by phase and processing. The working condition transition mode is defined as yₐ_{₁}, yₐ_{₂}, . . . , which indicates that a working condition type yₐ_{₁} appears firstly, then a working condition type yₐ_{₂} appears and next a working condition type yₐ_{₃} appears, and so on, wherein 1≤a₁, a₂, a₃≤n, and n represents the number of the parameters after dimension reduction. FIG. 3 shows a schematic diagram of a working condition transition mode with a window size of 2. Steps: continuously taking the working condition transition mode (yᵢ, yᵢ₊₁, . . . , y_{M}, y_{M+1}) with a sliding window size of M for the data set (t′ᵢ, x′ᵢ₁, x′ᵢ₂, . . . , x′ᵢₙ, y′_{k′}) to be processed according to the chronological order; inquiring and counting the probability p in the working condition transition probability model; if p>ϵ, continuing to compute the working condition of the time sequence of a next group of data parameters; if 0≤p≤ϵ, correcting a corresponding probability in the working condition transition probability' model wherein r represents a probability value defined according to expert knowledge.

The process of correcting the working condition transition probability model is specifically as follows:

(1) When p=0, it indicates that the working condition transition mode appears for the first time.

The working condition transition modes to be added are assumed as yₐ₁, yₐ₂, yₐ₃ . . . yₐ₄, y_{aM+1}.

Probability values P(yₐ_{_{M+1}}|yₐ_{₁}, yₐ_{₂}, yₐ_{₃}, . . . , yₐ_{_{M}}) of the Working condition transition modes yₐ_{₁}, yₐ_{₂}, yₐ_{₃}, . . . , yₐ_{_{M}}, yₐ_{_{M+1}} to be corrected are added to the working condition transition probability model, and recorded as ϵ; and accordingly, the probability values of other working condition transition modes in the data set of the working condition transition probability model are reduced on average.

(2) When 0≤p≤ϵ, it indicates that the appearance probability of the working condition transition mode is very low. The working condition transition modes to be modified are assumed as yₐ_{₁}, yₐ_{₂}, yₐ_{₃}, . . . , yₐ_{_{M}}, yₐ_{_{M+1}}.

The probability P(yₐ_{_{M+2}}|yₐ_{₁}, yₐ_{₂}, yₐ_{₃}, . . . , yₐ_{_{M}}) of modifying yₐ_{₁}, yₐ_{₂}, yₐ_{₃}, . . . , yₐ_{_{M}}, yₐ_{_{M+1}} in the working condition transition probability model is p+ϵ; and accordingly, the probability values of other working condition transition modes in the data set of the working condition transition probability model are reduced on average.

wherein ∈ represents a probability value defined according to expert knowledge, and ∈<68 .

1. A working condition state modeling and model correcting method, characterized by comprising the following steps:
step 1: collecting data, and arranging the data in a chronological order to form a time sequence data set;
step 2: preprocessing the time sequence data set;
step 3: clustering the preprocessed time sequence data set, computing a central point data set of the cluster, and generating a working condition data set and a working condition process data set;
step 4: counting a working condition transition probability for the working condition process data set to form a working condition transition probability model data set;
step 5: collecting the data, and detecting and processing the data,
step 6: computing a working condition state transition mode phase by phase and processing.

2. The working condition state modeling and model correcting method according to claim 1, characterized in that the step 1 comprises:
marking time sequence labels for the collected data (x₁, x₂, . . . , xₘ) to form a time sequence data set (tᵢ, xᵢ₁, xᵢ₂, . . . , xᵢₘ), wherein in represents the number of parameters; tᵢ represents the time sequence labels which are gradually increased; and x represents different parameters.

3. The working condition state modeling and model correcting method according to claim 1, characterized in that the step 2 comprises:
deleting irrelevant parameters in the time sequence data in the time sequence data set (tᵢ, xᵢ₁, xᵢ₂, . . . , xᵢₘ) to obtain a time sequence data set (tᵢ, xᵢ₁, xᵢ₂, . . . , xᵢₙ) after dimension reduction, n≤m, wherein tᵢ represents the time sequence labels which are gradually increased; m represents the number of parameters; n represents the number of parameters after dimension reduction; and x represents different parameters.

4. The working condition state modeling and model correcting method according to claim 3, characterized in that the dimension reduction comprises:
respectively computing a variance for each dimension of the parameters to obtain (σ₁, σ₂, . . . , σₘ); computing the mean value
$$\overline{σ} = \frac{( {σ}_{1} + {σ}_{2} + ⋯ + {σ}_{m} )}{m}$$
of the variance, and deleting the values in (σ₁, σ₂, . . . , σₘ) that are less than σ̅ to obtain (σ₁, σ₂, . . . , σₙ), thereby obtaining a time sequence data set (tᵢ, xᵢ₁, xᵢ₂, . . . , xᵢₙ) after dimension reduction, wherein tᵢ represents the time sequence labels which are gradually increased; m represents the number of parameters; n represents the number of parameters after dimension reduction; x represents different parameters; and σₘ represents variances of corresponding parameters.

5. The working condition state modeling and model correcting method according to claim 1, characterized in that a k-means algorithm is used for clustering, specifically:
the input serving as a data set (xᵢ₁, xᵢ₂, . . . , xᵢₙ) after dimension reduction, the range of k values being [Kₘᵢₙ, Kₘₐₓ];
conducting k-means clustering on the data set (xᵢ₁, xᵢ₂, . . . , xᵢₙ) after dimension reduction for each k value, and solving the sum of squared errors (SSE) value in clusters for each clustering result;
using cluster partitions (C₁, C₂, . . . , C_{K}) as output when min(SSE) is taken,
wherein C₁, C₂, . . . , C_{K} represent a set of clusters, and K represents the number of partitioned clusters, i.e., the number of working condition types.

6. The working condition state modeling and model correcting method according to claim 1, characterized in that the generating the working condition data set and the working condition process data set comprises:
firstly, marking the cluster partitions (C₁, C₂, . . . , C_{K}) of the data set (xᵢ₁, xᵢ₂, . . . , xᵢₙ) with the working condition types to form a working condition data set expressed as (xᵢ₁,ᵢ₂, . . . , xᵢₙ, yₖ); and simultaneously, respectively computing the central points of the cluster partitions to form a central point data set (cₖ₁, cₖ₂, . . . , cₖₙ, yₖ), wherein y represents the working condition types and the number of y is the same as the number of the cluster partitions, i.e., k≤K; C represents parameters corresponding to the working condition data set (xᵢ₁, xᵢ₂, . . . , xᵢₙ, yₖ);
then, computing a distance from each data in a cluster to a central node in the cluster, and taking a maximum distance value Dₘₐₓ;
finally, adding the time sequence labels for the working condition data set by taking the time sequence data set as a reference, to form a working condition process data set expressed as (tᵢ, xᵢ₁, xᵢ₂, . . . xᵢₙ, yₖ), wherein y represents the working condition types and the number of y is the same as the number of the cluster partitions, i.e., k≤K; tᵢ represents the time sequence labels which are gradually increased.

7. The working condition state modeling and model correcting method according to claim 1, characterized in that the working condition transition probability model data set is P(yₐ_{_{M+1}}|yₐ_{₁}, yₐ_{₂}, yₐ_{₃}, . . . , yₐ_{_{M}}), wherein M is a window size;
$$⌊ M \leq \frac{K}{2} ⌋ ;$$
K is the number of the working condition types; 1≤a₁, a₂, a₃, a_{M}, a_{M+1}≥n; and n represents the number of the parameters after dimension reduction.

8. The working condition state modeling and model correcting method according to claim 1, characterized in that in the working condition transition mode yₐ_{₁}, yₐ_{₂}, yₐ_{₃}, . . . , yₐ_{ₘ}, a working condition type yₐ_{₁} appears firstly, then a working condition type yₐ_{₂}, appears and next a working condition type yₐ_{₃} appears, and so on until the working condition type yₐ_{ₘ} appears, wherein 1≤a₁, a₂, a₃, aₘ≤n, and n represents the number of the parameters after dimension reduction.

9. The working condition state modeling and model correcting method according to claim 1, characterized in that the collecting the data, and detecting and processing the data comprises:
collecting the data and taking n-dimensional parameters as input data (x′₁, x′₂, . . . , x′ₙ), wherein n represents the number of the parameters after dimension reduction, and the parameters are the same as the parameters selected in the data set (xᵢ₁, xᵢ₂, . . . , xᵢₙ) after dimension reduction;
computing a distance from the input data to the central point data set, and taking a minimum value d of the distance;
if d≤Dₘₐₓ taking the working condition type of the central point with a distance of d; adding the time sequence labels to form time sequence data (t′, x′₁, x′₂, . . . , x′ₙ, y′); and saving the data into a data set (t′ⱼ, x′ᵢ₁, x′ᵢ₂, . . . , x′ᵢₙ, y′_{k′}) to be processed;
d>Dₘₐₓ indicating that the input data is not matched with any working condition type; and
modifying the working condition data set and the central point data set, wherein Dₘₐₓ represents the maximum value of the distance from each data in the cluster to the central node in the cluster.

10. The working condition state modeling and model correcting method according to claim 1, characterized in that the step 6 comprises:
continuously taking the working condition transition mode (yᵢ, yᵢ₊₁, . . . , y_{M}, y_{M+1}) with a sliding window size of M for the data set (t′ᵢ, x′ᵢ₁, x′ᵢ₂, . . . , x′ᵢₙ, y′_{k′})to be processed according to the chronological order; inquiring and counting the probability p in the working condition transition probability model; if p>ϵ, continuing to compute the working condition of the time sequence of a next group of data parameters; if 0≤p≤ϵ, correcting a corresponding probability in the working condition transition probability model, wherein ϵ represents a probability value defined according to expert knowledge.

11. The working condition state modeling and model correcting method according to claim 10, characterized in that the corresponding probability in the working condition transition probability model comprises:
when p=0, adding a probability value of the working condition transition mode to be corrected to the working condition transition probability model, recorded as ∈; accordingly, reducing the probability values of other working condition transition modes in the data set of the working condition transition probability model on average;
when 0<p≤ϵ, modifying the probability value of the working condition transition mode to be corrected to the working condition transition probability model, recorded as p+∈;
accordingly, reducing the probability values of other working condition transition modes in the data set of the working condition transition probability model on average, wherein ∈ represents a probability value defined according to expert knowledge, and ∈<ϵ.
